(19) United States
(12) Patent Application Publication
(10) Pub. No.: US 2025/0149755 A1
(43) Pub. Date: May 8, 2025

(54) BATTERY

(71) Applicant: TOYOTA JIDOSHA KABUSHIKI KAISHA, Toyota-shi (JP)

(72) Inventor: Sadao FUJISAKI, Toyota-shi (JP)

(73) Assignee: TOYOTA JIDOSHA KABUSHIKI KAISHA, Toyota-shi (JP)

(21) Appl. No.: 18/923,124

(22) Filed: Oct. 22, 2024

(30) Foreign Application Priority Data
Nov. 6, 2023 (JP) 2023-189147

(51) Int. Cl. H01M 50/54; H01M 50/159; H01M 50/548

(52) U.S. Cl. CPC H01M 50/54; H01M 50/159; H01M 50/548

(57) ABSTRACT

In a battery including an electrode laminated body in the interior of an outer packaging body, an end-surface positive electrode current collector is disposed on one surface of the electrode laminated body in a lamination direction, an end-surface negative electrode current collector is disposed on the other surface of the electrode laminated body in the lamination direction, an internal current collector is laminated in the interior of the electrode laminated body, the internal current collector includes a connection portion, a positive electrode terminal is disposed, a negative electrode terminal is disposed, a connection terminal is disposed, and in the interior of the outer packaging body, the end-surface positive electrode current collector and the positive electrode terminal are electrically connected, the end-surface negative electrode current collector and the negative electrode terminal are electrically connected, and the connection portion and the connection terminal are electrically connected.

### CROSS-REFERENCE TO RELATED APPLICATION

This application claims priority to Japanese Patent Application No. 2023-189147 filed on Nov. 6, 2023, incorporated herein by reference in its entirety.

### BACKGROUND

### 1. Technical Field

The present application relates to a battery.

### 2. Description of Related Art

Japanese Unexamined Patent Application Publication No. 2019-53845 (JP 2019-53845 A) discloses a current collecting plate disposition structure for a bipolar battery in which a voltage monitoring terminal (current collecting plate) extends along a lamination direction between an outer surface of a side-wall sealing material or a battery cell laminated body and the side-wall sealing material and an end portion of the voltage monitoring terminal is disposed on an upper surface of an upper-wall sealing material. JP 2019-53845 A describes that the occupation area of the voltage monitoring terminal on a cell side surface can be reduced because the voltage monitoring terminal is disposed on the upper surface of the upper-wall sealing material.

### SUMMARY

However, in the current collecting plate disposition structure in JP 2019-53845 A, a through-hole is provided on an outer packaging member, and from the through-hole, an electrode and the voltage monitoring terminal are drawn out to the outside. Therefore, there is room for improvement in the enhancement in airtight property and gas barrier property.

Hence, in view of the above circumstance, a main object of the present disclosure is to provide a battery that makes it possible to enhance airtight property and gas barrier property and to enhance structural efficiency.

The present disclosure provides at least the following aspects.

A first aspect is a battery including an electrode laminated body in an interior of an outer packaging body, in which: an end-surface positive electrode current collector is disposed on one surface of the electrode laminated body in a lamination direction; an end-surface negative electrode current collector is disposed on the other surface of the electrode laminated body in the lamination direction; an internal current collector is laminated in the interior of the electrode laminated body; the internal current collector includes a connection portion that is drawn out from a side surface of the electrode laminated body; a positive electrode terminal is disposed on one surface of the outer packaging body in the lamination direction; a negative electrode terminal is disposed on the other surface of the outer packaging body in the lamination direction; a connection terminal is disposed on an identical surface to the surface on which at least one of the positive electrode terminal and the negative electrode terminal is disposed; and in the interior of the outer packaging body, the end-surface positive electrode current collector and the positive electrode terminal are electrically connected, the end-surface negative electrode current collector and the negative electrode terminal are electrically connected, and the connection portion and the connection terminal are electrically connected.

A second aspect is the battery according to the first aspect, in which: the outer packaging body is composed of metal; and the connection terminal includes a through-hole that passes through an end surface of the outer packaging body in the lamination direction, a metal portion that is disposed in the through-hole, and an insulation layer that is disposed between the through-hole and the metal portion.

A third aspect is the battery according to the second aspect, in which the insulation layer is disposed on an inside portion of the through-hole, or on an inside peripheral portion and an outside peripheral portion of the outer packaging body that are continuous with the through-hole.

A fourth aspect is the battery according to any one of the first to third aspects, in which in the interior of the outer packaging body, the respective end-surface current collectors and the respective electrode terminals contact directly with each other, and the connection portion and the connection terminal contact directly with each other.

With the battery in the present disclosure, it is possible to enhance airtight property and gas barrier property and to enhance structural efficiency.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view of a battery 100;

FIG. 2A is a sectional view of the battery 100 taken from II-II in FIG. 1;

FIG. 2B is an exploded sectional view of the battery 100;

FIG. 3 is a plan view of an electrode laminated body 50;

FIG. 4A is an elevational view of the electrode laminated body 50 as viewed from an A-direction in FIG. 3;

FIG. 4B is a side view of the electrode laminated body 50 as viewed from a B-direction in FIG. 3;

FIG. 5A is a plan view of an internal current collector 20;

FIG. 5B is a diagram showing a plurality of internal current collectors 20 for describing differences in the position and length of a connection portion 22;

FIG. 6 is a sectional view of the electrode laminated body 50 that is an example;

FIG. 7 is a partial sectional view focusing on a connection terminal 70; and

FIG. 8 shows an example of a method for providing the connection terminal 70 on an outer packaging body 90.

### DETAILED DESCRIPTION OF EMBODIMENTS

A battery in the present disclosure will be described with use of a battery 100 that is an embodiment.

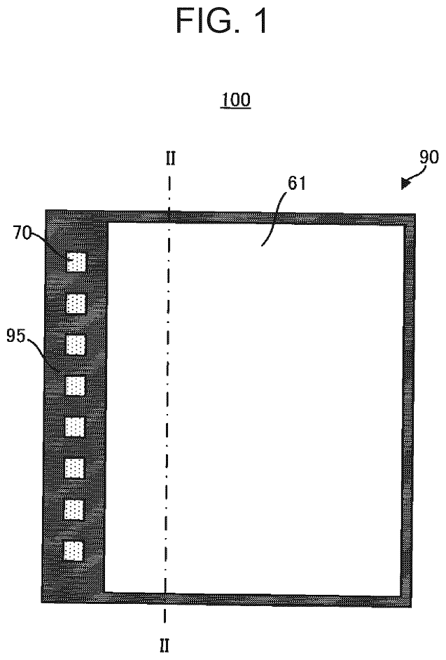

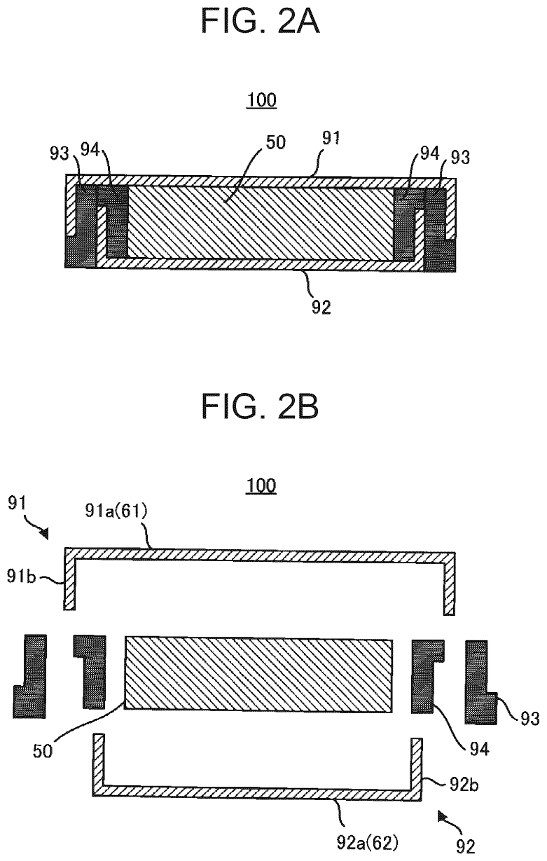

FIG. 1 shows a plan view of the battery 100. FIG. 2A is a sectional view of the battery 100 taken from II-II in FIG. 1, and FIG. 2B shows an exploded sectional view of the battery 100. As shown in FIG. 1, FIG. 2A, and FIG. 2B, the battery 100 includes an electrode laminated body 50 and an outer packaging body 90, and includes the electrode laminated body 50 in the interior of the outer packaging body 90.

### Electrode Laminated Body 50

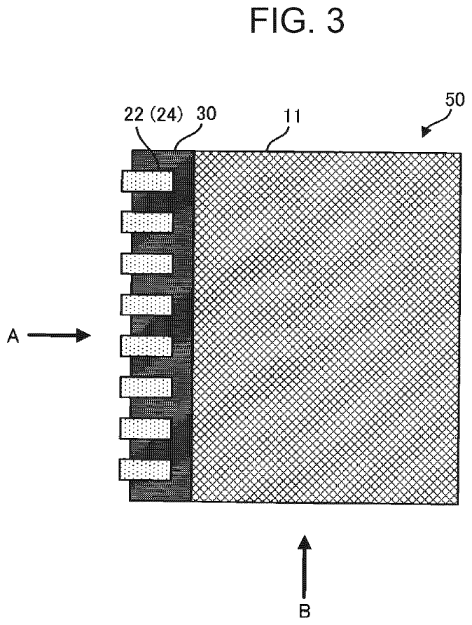

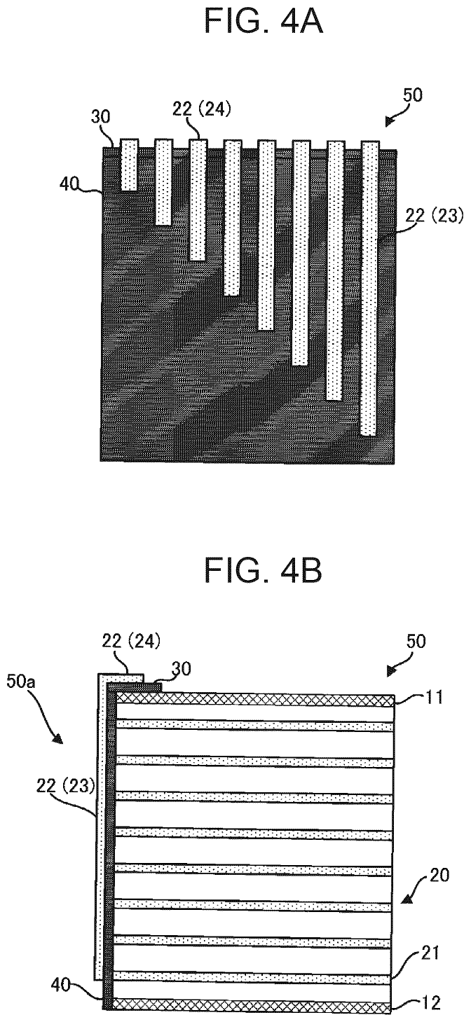

First, the electrode laminated body 50 will be described. FIG. 3 shows a plan view of the electrode laminated body 50. FIG. 4A is an elevational view of the electrode laminated body 50 as viewed from an A-direction in FIG. 3, and FIG. 4B is a side view of the electrode laminated body 50 as viewed from a B-direction in FIG. 3.

The electrode laminated body 50 is a laminated body that has a rectangular shape in lamination-directional view and that includes current collectors (a positive electrode current collector and a negative electrode current collector), a positive electrode layer, a negative electrode layer, and an electrolyte layer. In the electrode laminated body 50, the number of laminated layers is not particularly limited, and may be appropriately set depending on purpose. The lamination form of the electrode laminated body 50 is not particularly limited, and may be a monopolar type, or may be a bipolar type. The electrode laminated body 50 may be a liquid state battery, or may be a solid state battery. The electrode laminated body 50 may be a lithium-ion battery, may be a sodium-ion battery, or may be a nickel-hydrogen battery, or the like. The electrode laminated body 50 may be a primary battery, or may be a secondary battery.

### Material of Electrode Laminated Body 50

The materials of the respective layers that constitute the electrode laminated body 50 will be described with typical examples. However, the materials of the respective layers that constitute the electrode laminated body 50 are not limited to the typical examples.

The current collector is a sheet-shaped conductive member. Examples of the current collector include a metal foil composed of stainless steel, iron, copper, aluminum, titanium, nickel, or the like. The metal foil may be composed of an alloy that contains two or more kinds of these metals. Further, for the metal foil, a predetermined surface treatment such as plating may be performed. The current collector may be constituted by a plurality of metal foils. In this case, the metal foils may be united by an adhesive or the like, or may be united by pressing or the like. The shape of the current collector may be a rectangular shape. The thickness of the current collector is not particularly limited, and is 1 μm to 1 mm, for example.

The positive electrode layer contains at least a positive electrode active material. The positive electrode active material is not particularly limited, and an arbitrary material may be appropriately selected depending on intended battery performance. For example, there are a composite oxide, a metallic lithium, sulfur, and the like. For example, the composition of the composite oxide includes at least one of iron, manganese, titanium, nickel, cobalt, and aluminum, and lithium. Examples of the composite oxide include olivine lithium iron phosphate (LiFePO₄).

The positive electrode layer may arbitrarily contain a conductive auxiliary agent. The conductive auxiliary agent is not particularly limited, and an arbitrary material may be appropriately selected depending on intended battery performance. For example, there are carbon materials such as acetylene black, carbon black, and graphite.

The positive electrode layer may arbitrarily contain a binding agent. The binding agent is not particularly limited, and an arbitrary material may be appropriately selected depending on intended battery performance. For example, there are a rubber resin, a fluoride resin, and the like.

The positive electrode layer may arbitrarily contain a solid electrolyte. The solid electrolyte is not particularly limited, and an arbitrary material may be appropriately selected depending on intended battery performance. For example, there are a solid oxide electrolyte, a solid sulfide electrolyte, and the like.

The positive electrode layer may have a rectangular shape. The thickness of the positive electrode layer is not particularly limited, and is in a range of 1 μm to 1 mm, for example. The area of the positive electrode layer may be smaller than the area of the negative electrode layer. The content of each material in the positive electrode layer is not particularly limited, and may be appropriately set depending on intended battery performance. The positive electrode layer may contain materials other than the above materials.

The negative electrode layer contains a negative electrode active material. The negative electrode active material is not particularly limited, and an arbitrary material may be appropriately selected depending on intended battery performance. For example, there are a carbon material such as black lead, artificial black lead, hard carbon, and soft carbon, a metallic compound, an element that can alloy together with lithium, a compound of the element that can alloy together with lithium, and the like. Examples of the element that can alloy together with lithium include silicon and tin.

The negative electrode layer may arbitrarily contain a conductive auxiliary agent. The conductive auxiliary agent is not particularly limited, and an arbitrary material may be appropriately selected depending on intended battery performance. For example, a conductive auxiliary agent that can be applied to the positive electrode layer may be appropriately selected.

The negative electrode layer may arbitrarily contain a binding agent. The binding agent is not particularly limited, and an arbitrary material may be appropriately selected depending on intended battery performance. For example, a binding agent that can be applied to the positive electrode layer may be appropriately selected.

The negative electrode layer may arbitrarily contain a solid electrolyte. The solid electrolyte is not particularly limited, and an arbitrary material may be appropriately selected depending on intended battery performance. For example, a solid electrolyte that can be applied to the positive electrode layer may be appropriately selected.

The negative electrode layer may have a rectangular shape. The thickness of the negative electrode layer is not particularly limited, and is in a range of 1 μm to 1 mm, for example. From a standpoint of output enhancement, the area of the negative electrode layer may be larger than the area of the positive electrode layer. The content of each material in the negative electrode layer is not particularly limited, and may be appropriately set depending on intended battery performance. The negative electrode layer may contain materials other than the above materials.

In the case where the electrolyte layer is a liquid electrolyte layer, the electrolyte layer contains a separator and an electrolytic solution. The separator is mainly a porous polyolefin sheet. The electrolytic solution is a solution in which a supporting electrolyte is dissolved in a nonaqueous solvent. As the nonaqueous solvent, there are carbonate solvents, ether solvents, ester solvents, and the like. As the supporting electrolyte, for example, there are LiPF₆, LiBF₄, lithium bis (fluorosulfonyl) imide (LiFSI), lithium bis (trifluoromethane) sulfonimide (LiTFSI), and the like.

In the case where the electrolyte layer is a solid electrolyte layer, the electrolyte layer contains a solid electrolyte. Further, the solid electrolyte layer may contain a binding agent. The solid electrolyte and the binding agent may be appropriately selected from the above-described solid electrolytes and bonding agents.

The electrolyte layer may have a rectangular shape. The thickness of the electrolyte layer is not particularly limited, and is in a range of 1 μm to 1 mm, for example.

### End-Surface Positive Electrode Current Collector 11, End-Surface Negative Electrode Current Collector 12, Internal Current Collector 20

As shown in FIG. 3, FIG. 4A, and FIG. 4B, the electrode laminated body 50 includes a positive electrode current collector (also referred to as an “end-surface positive electrode current collector 11” in the present specification) disposed on one surface in the lamination direction and a negative electrode current collector (also referred to as an “end-surface negative electrode current collector 12” in the present specification) disposed on the other surface. Further, the electrode laminated body 50 includes current collectors (also referred to as “internal current collectors 20” in the present specification) in the interior. Layers other than the end-surface positive electrode current collector 11, the end-surface negative electrode current collector 12, and the internal current collectors 20 vary depending on an intended battery, and therefore are not specifically illustrated in FIG. 4B.

The number of internal current collectors 20 is not particularly limited, and may be appropriately set depending on purpose. In FIG. 3, FIG. 4A, and FIG. 4B, a plurality of internal current collectors 20 (eight internal current collectors 20) is disposed in the interior of the electrode laminated body 50. The internal current collectors 20 may be positive electrode current collectors, or may be negative electrode current collectors. Further, the internal current collectors 20 may be an identical kind of current collectors, or may be different kinds of current collectors. The internal current collectors 20 play a role in providing battery information to the exterior, as described later, and therefore, all internal current collectors 20 may be constituted by an identical kind of current collectors (preferably, positive electrode current collectors). Further, the electrode laminated body 50 may include, in the interior, an ordinary current collector other than the internal current collectors 20.

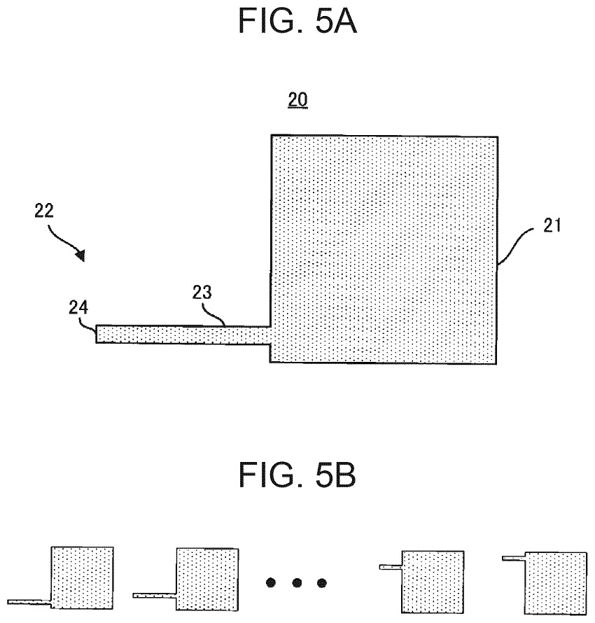

As a characteristic, the internal current collector 20 includes a connection portion 22 that is drawn out from a side surface of the electrode laminated body 50, unlike the other current collectors. FIG. 5A shows a plan view of the internal current collector 20, and FIG. 5B shows a plurality of internal current collectors 20 for describing differences in the position of the connection portion 22.

As shown in FIG. 5A, the internal current collector 20 includes a main body portion 21 and the connection portion 22. The main body portion 21 is a portion that is laminated in the interior of the electrode laminated body 50 and that functions as a current collector. Accordingly, on the main body portion 21, the positive electrode layer or negative electrode layer is laminated. The main body portion 21 has a rectangular shape. On the other hand, the connection portion 22 is a portion for providing the battery information (information about voltage, electric current, and the like) to the exterior, and has an elongated belt shape. For example, the connection portion 22 is used as a voltage monitoring line. As shown in FIG. 3, FIG. 4A, and FIG. 4B, the connection portion 22 is formed so as to be drawn out from a side surface 50a of the electrode laminated body 50, and the drawn-out connection portion 22 is folded in the lamination direction. Moreover, an end portion of the connection portion 22 is further folded, and is disposed on the identical surface to the surface on which the end-surface positive electrode current collector 11 is disposed. In this way, the connection portion 22 is characterized in that the connection portion 22 extends along the side surface 50a of the electrode laminated body 50 in the lamination direction and is disposed on the identical surface to the surface on which the end-surface positive electrode current collector 11 is disposed.

In this way, the connection portion 22 is characterized in that the connection portion 22 extends along the side surface of the electrode laminated body 50 in the lamination direction and is disposed on the identical surface to the surface on which the end-surface positive electrode current collector 11 is disposed. Conventional batteries have a shape in which the connection portion to function as the voltage monitoring line is merely drawn out in a side surface direction. On the other hand, in the battery 100, the connection portion 22 has a portion that extends along the side surface of the electrode laminated body 50 in the lamination direction, and thereby, it is possible to reduce the area of the connection portion 22 on the whole of the battery 100. Further, in JP 2019-53845 A, the outer packaging member having a through-hole through which the voltage monitoring terminal is drawn out to the outside is required, and the structure of the outer packaging member is restricted. On the other hand, in the battery 100, the connection portion 22 is disposed on the identical surface to the surface on which the end-surface positive electrode current collector 11 is disposed, and thereby, it is possible to enhance structural efficiency in a simple structure.

In the connection portion 22, a portion that is drawn out from the side surface of the electrode laminated body 50 and that extends along the side surface 50a in the lamination direction is referred to as an extension portion 23, and a portion that is disposed on the identical surface to the surface on which the end-surface positive electrode current collector 11 is disposed is referred to as an end portion 24.

As shown in FIG. 5B, the position of the connection portion 22 in the internal current collector 20 is not particularly limited, but as shown in FIG. 3, FIG. 4A, and FIG. 4B, the connection portions 22 drawn out from the plurality of internal current collectors 20 may be disposed so as not to overlap with each other in lamination-directional view. Thereby, it is possible to restrain the contact among the connection portions 22, and to simplify the battery structure. Further, as shown in FIG. 5B, the length of the connection portion 22 may be arbitrarily set depending on the position of the end portion 24.

Here, “the connection portion 22 is disposed on the identical surface to the surface on which the end-surface positive electrode current collector 11 is disposed” will be further described. As shown in FIG. 3, FIG. 4A, and FIG. 4B, the end portion 24 of the connection portion 22 is disposed on the end-surface positive electrode current collector 11 through an end-surface insulation layer 30. Therefore, strictly speaking, the end portion 24 of the connection portion 22 is not disposed on the identical surface to the surface on which the end-surface positive electrode current collector 11 is disposed. However, the end-surface insulation layer 30 is a very thin layer, and therefore, it can be said that the end portion 24 of the connection portion 22 and the end-surface positive electrode current collector 11 are disposed on the identical surface, from a standpoint of use. Accordingly, “the connection portion 22 is disposed on the identical surface to the surface on which the end-surface positive electrode current collector 11 is disposed” does not strictly mean that the end portion 24 of the connection portion 22 is disposed on the identical surface to the surface on which the end-surface positive electrode current collector 11 is disposed, and means that the end portion 24 of the connection portion 22 only needs to be disposed on the identical surface to the surface on which the end-surface positive electrode current collector 11 is disposed from a standpoint of use.

In the electrode laminated body 50, the connection portion 22 is disposed on the identical surface to the surface on which the end-surface positive electrode current collector 11 is disposed, but the present disclosure is not limited to this. The connection portion 22 may be disposed on the identical surface to the surface on which the end-surface negative electrode current collector 12 is disposed. Further, some of the plurality of connection portions 22 may be disposed on the identical surface to the surface on which the end-surface positive electrode current collector 11 is disposed, and the other of the plurality of connection portions 22 may be disposed on the identical surface to the surface on which the end-surface negative electrode current collector 12 is disposed. Accordingly, each connection portion 22 may extend along the side surface 50a of the electrode laminated body 50 in the lamination direction, and may be disposed on the identical surface to the surface on which at least one of the end-surface positive electrode current collector 11 and the end-surface negative electrode current collector 12 is disposed.

### End-Surface Insulation Layer 30

The electrode laminated body 50 includes the end-surface insulation layer 30. The end-surface insulation layer 30 is disposed on at a part of the end-surface positive electrode current collector 11. Moreover, the connection portions 22 (the end portions 24) are disposed on the end-surface positive electrode current collector 11 through the end-surface insulation layer 30, and the end portions 24 and the end-surface positive electrode current collector 11 are insulated by the end-surface insulation layer 30. In this way, the end-surface insulation layer 30 is disposed between the end portions 24 and the end-surface positive electrode current collector 11, and plays a role in insulating the end portions 24 and the end-surface positive electrode current collector 11.

The material of the end-surface insulation layer 30 is not particularly limited, and for example, there are polyimide, polypropylene, polyethylene, polyvinylchloride, polytetrafluoroethylene, and the like. The thickness of the end-surface insulation layer 30 is not particularly limited, and is 5 μm to 300 μm, for example. The disposition method for the end-surface insulation layer 30 is not particularly limited, and for example, a resin tape may be sticked to the end-surface positive electrode current collector 11. Further, a resin sheet may be disposed between the end-surface positive electrode current collector 11 and the end portions 24 of the connection portions 22. Alternatively, a resin material may be applied to the end-surface positive electrode current collector 11.

The end-surface insulation layer 30 may be disposed on the end portions 24. Even when the end-surface insulation layer 30 is disposed on the end portions 24, the end portions 24 and the end-surface positive electrode current collector 11 can be insulated by the end-surface insulation layer 30. Accordingly, the end-surface insulation layer 30 only needs to be disposed between the end portions 24 and the end-surface positive electrode current collector 11.

### Side-Surface Insulation Layer 40

The electrode laminated body 50 includes a side-surface insulation layer 40. The side-surface insulation layer 40 is disposed on the side surface 50a of the electrode laminated body 50. Moreover, the connection portions 22 (the extension portions 23) and the side surface 50a of the electrode laminated body 50 are insulated by the side-surface insulation layer 40. In this way, the side-surface insulation layer 40 is disposed on the side surface 50a, and plays a role in insulating the extension portions 23 and the side surface 50a. Accordingly, the side-surface insulation layer 40 only needs to be disposed on at least a part of the side surface 50a. The side-surface insulation layer 40 may be disposed on the whole of the side surface 50a.

The material of the side-surface insulation layer 40 is not particularly limited, and for example, there are polyimide, polypropylene, polyethylene, polyvinylchloride, polytetrafluoroethylene, and the like. The thickness of the side-surface insulation layer 40 is not particularly limited, and is 5 μm to 300 μm, for example. The disposition method for the side-surface insulation layer 40 is not particularly limited, and for example, a resin tape may be sticked to the side surface 50a of the electrode laminated body 50. Further, a resin sheet may be disposed between the side surface 50a of the electrode laminated body 50 and the extension portions 23 of the connection portions 22. Alternatively, a resin material may be applied to the side surface 50a of the electrode laminated body 50.

The side-surface insulation layer 40 may be disposed on the extension portions 23. Even when the side-surface insulation layer 40 is disposed on the extension portions 23, the extension portions 23 and the side surface 50a of the electrode laminated body 50 can be insulated by the side-surface insulation layer 40. Accordingly, the side-surface insulation layer 40 only needs to be disposed on at least one of the extension portions 23 and the side surface 50a of the electrode laminated body 50.

### Lamination Form of Electrode Laminated Body 50

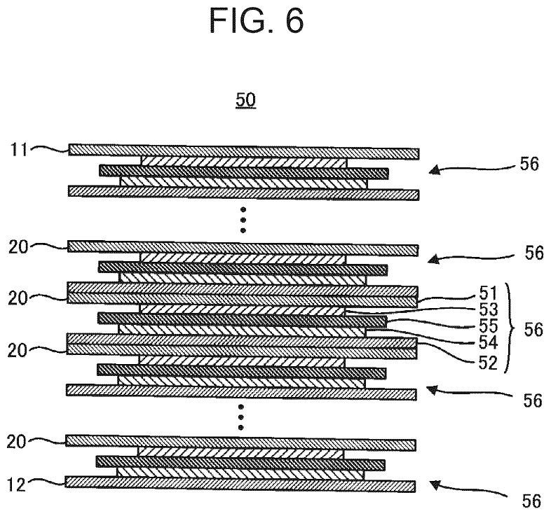

As described above, the electrode laminated body 50 is a laminated body that includes the current collectors, the positive electrode layer, the electrolyte layer, and the negative electrode layer. The end-surface current collectors 11, 12 are laminated on both surfaces of the electrode laminated body 50 in the lamination direction, and the plurality of internal current collectors 20 is included in the interior of the electrode laminated body 50. The other configuration is not particularly limited. FIG. 6 shows sectional views of the electrode laminated body 50 that is an example. The electrode laminated body 50 shown in FIG. 6 is an electrode laminated body for a bipolar-type lithium-ion secondary battery.

As shown in FIG. 6, in the electrode laminated body 50, a plurality of electrode bodies 56 is laminated. In the electrode laminated body 50, the number of electrode bodies 56 is not particularly limited, and may be appropriately set depending on purpose.

The electrode body 56 includes a positive electrode current collector 51, a negative electrode current collector 52, a positive electrode layer 53, a negative electrode layer 54, and an electrolyte layer 55. The electrode body 56 is formed by overlapping the negative electrode layer 54 disposed on an upper surface of the negative electrode current collector 52 and the positive electrode layer 53 disposed on a lower surface of the positive electrode current collector 51 such that the electrolyte layer 55 is interposed. Moreover, the electrode laminated body 50 is formed such that the plurality of electrode bodies 56 is laminated so as to be connected in series.

The positive electrode current collector 51 disposed on one surface of the electrode laminated body 50 in the lamination direction corresponds to the end-surface positive electrode current collector 11, and the negative electrode current collector 52 disposed on the other surface in the lamination direction corresponds to the end-surface negative electrode current collector 12. Further, the positive electrode current collector 51 or the negative electrode current collector 52 included in the interior of the electrode laminated body 50 corresponds to the internal current collector 20. In FIG. 6, the internal current collector 20 is the positive electrode current collector 51 included in the interior of the electrode laminated body 50.

### Outer Packaging Body 90

As shown in FIG. 1, FIG. 2A, and FIG. 2B, the outer packaging body 90 is composed of metal, and has a rectangular shape in lamination-directional view. The outer packaging body 90 is a box-shaped member having a space in which the electrode laminated body 50 can be housed in the interior.

### Basic Structure of Outer Packaging Body 90

First, a basic configuration of the outer packaging body 90 will be described. The outer packaging body 90 includes a positive electrode outer packaging body 91 and a negative electrode outer packaging body 92. Further, the outer packaging body 90 includes insulating resins 93, 94.

The positive electrode outer packaging body 91 is composed of metal, and has a box shape in which a rectangular bottom plate 91a and four side plates 91b sharing the sides of the bottom plate 91a are included. That is, the positive electrode outer packaging body 91 has such a shape that a section has a U-shape. Further, in the positive electrode outer packaging body 91, a surface that faces the bottom plate 91a is opened. The negative electrode outer packaging body 92 is composed of metal, and has a box shape in which a rectangular bottom plate 92a and four side plates 92b sharing the sides of the bottom plate 92a are included. That is, the negative electrode outer packaging body 92 has such a shape that a section has a U-shape. Further, in the negative electrode outer packaging body 92, a surface that faces the bottom plate 92a is opened. Moreover, the positive electrode outer packaging body 91 and the negative electrode outer packaging body 92 are overlapped with each other, such that the bottom plates face each other in the lamination direction and the side plates face each other in a direction orthogonal to the lamination direction. Thereby, the space in which the electrode laminated body 50 can be housed can be formed in the interior of the outer packaging body 90.

The bottom plate 91a of the positive electrode outer packaging body 91 is formed so as to have a larger area than the bottom plate 92a of the negative electrode outer packaging body 92. Therefore, when the electrode laminated body 50 is housed in the outer packaging body 90, the side plates 92b of the negative electrode outer packaging body 92 are disposed on the inside of the side plates 91b of the positive electrode outer packaging body 91.

The metal composing the positive electrode outer packaging body 91 and the negative electrode outer packaging body 92 is not particularly limited, and for example, there are aluminum, an aluminum alloy, stainless steel, copper, a cooper alloy, nickel steel, and the like. The thicknesses of the positive electrode outer packaging body 91 and the negative electrode outer packaging body 92 are not particularly limited, and are 0.05 mm or more and 2.0 mm or less, for example.

The resin 93 is disposed between the side surface of the electrode laminated body 50 and the side plates 92b of the positive electrode outer packaging body 91. Thereby, the side surface of the electrode laminated body 50 and the side plates 92b of the positive electrode outer packaging body 91 can be insulated, and can be fixed. The resin 94 is disposed between the side plates 91b of the positive electrode outer packaging body 91 and the side plates 92b of the negative electrode outer packaging body 92. Thereby, the side plates 91b of the positive electrode outer packaging body 91 and the side plates 92b of the negative electrode outer packaging body 92 can be insulated, and can be fixed.

The above basic configuration of the outer packaging body 90 is described in Japanese Patent Application No. 2023-006850, for example.

### Characteristic Structure of Outer Packaging Body 90

Subsequently, a characteristic portion of the outer packaging body 90 will be described. The outer packaging body 90 includes a positive electrode terminal 61 disposed on one surface in the lamination direction, a negative electrode terminal 62 disposed on the other surface in the lamination direction, and a plurality of connection terminals 70 disposed on the identical surface to the surface on which the positive electrode terminal 61 is disposed.

The positive electrode terminal 61 is the bottom plate 91a of the positive electrode outer packaging body 91, and is a portion that is exposed to the exterior. Typically, on an inner surface of the bottom plate 91a of the positive electrode outer packaging body 91, an insulation layer may be disposed at a portion other than a portion that contacts with the end-surface positive electrode current collector 11, and on an outer surface of the bottom plate 91a, an insulation layer 95 may be disposed at a portion other than a portion that is connected to the exterior (see FIG. 1; not illustrated in FIG. 2A and FIG. 2B). In this case, the positive electrode terminal 61 is a portion that is on the bottom plate 91a of the positive electrode outer packaging body 91 and that is exposed to the exterior such that the insulation layer is not disposed. The same goes for the negative electrode terminal 62. The negative electrode terminal 62 is the bottom plate 92a of the negative electrode outer packaging body 92, and is a portion that is exposed to the exterior. Typically, on an inner surface of the bottom plate 92a of the negative electrode outer packaging body 92, an insulation layer may be disposed at a portion other than a portion that contacts with the end-surface negative electrode current collector 12, and on an outer surface of the bottom plate 92a, an insulation layer may be disposed at a portion other than a portion that is connected to the exterior. In this case, the negative electrode terminal 62 is a portion that is on the bottom plate 92a of the negative electrode outer packaging body 92 and that is exposed to the exterior such that the insulation layer is not disposed.

Both surfaces of the side plate 91b of the positive electrode outer packaging body 91 and both surfaces of the side plate 92b of the negative electrode outer packaging body 92 may be covered with insulation layers. Thereby, inner surfaces of the side plates of the outer packaging body 90 (inner surfaces of the side plates 92b of the negative electrode outer packaging body 92) and the electrode laminated body 50 can be insulated. Further, outer surfaces of the side plates of the outer packaging body 90 (outer surfaces of the side plates 91b of the positive electrode outer packaging body 91) and an external member can be insulated.

In the interior of the outer packaging body 90, the positive electrode terminal 61 contacts directly with the end-surface positive electrode current collector 11 of the electrode laminated body 50, and is electrically connected to the end-surface positive electrode current collector 11 of the electrode laminated body 50. In the interior of the outer packaging body 90, the negative electrode terminal 62 contacts directly with the end-surface negative electrode current collector 12 of the electrode laminated body 50, and is electrically connected to the end-surface negative electrode current collector 12 of the electrode laminated body 50. Accordingly, both end surfaces of the outer packaging body 90 in the lamination direction function as terminals. In this way, the positive electrode terminal 61 and the negative electrode terminal 62 are electrically connected to the end-surface positive electrode current collector 11 and end-surface negative electrode current collector 12 of the electrode laminated body 50, in the interior of the outer packaging body 90, and therefore, airtight property and gas barrier property are assured.

The positive electrode terminal 61 and the end-surface positive electrode current collector 11 contact directly with each other and are electrically connected in the interior of the outer packaging body 90, from a standpoint of structural efficiency, but the present disclosure is not limited to this form. The positive electrode terminal 61 and the end-surface positive electrode current collector 11 may be electrically connected indirectly through a conductive member or the like, in the interior of the outer packaging body 90. Similarly, the negative electrode terminal 62 and the end-surface negative electrode current collector 12 contact directly with each other and are electrically connected in the interior of the outer packaging body 90, from a standpoint of structural efficiency, but the present disclosure is not limited to this form. The negative electrode terminal 62 and the end-surface negative electrode current collector 12 may be electrically connected indirectly through a conductive member or the like, in the interior of the outer packaging body 90.

The connection terminals 70 are electrically connected to the connection portions 22 of the electrode laminated body 50, and play a role in providing information about the electrode laminated body 50 to the exterior. The connection terminals 70 are disposed on the bottom plate 91a of the positive electrode outer packaging body 91. That is, the connection terminals 70 are disposed on the identical surface to the surface on which the positive electrode terminal 61 is disposed. In the interior of the outer packaging body 90, the connection terminals 70 contact directly with the end portions 24 of the connection portions 22, and are electrically connected to the end portions 24 of the connection portions 22. The number of the connection terminals 70 corresponds to the number of the connection portions 22, and the connection terminals 70 are connected to the connection portions 22, respectively.

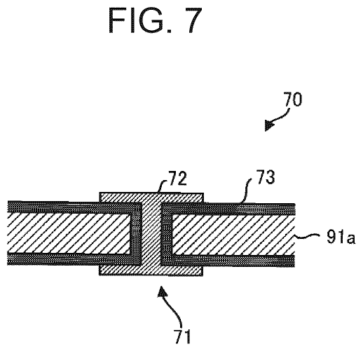

A specific configuration of the connection terminal 70 will be described. FIG. 7 shows a partial sectional view focusing on the connection terminal 70. As shown in FIG. 7, the connection terminal 70 includes a through-hole 71 that passes through the end surface of the outer packaging body 90 (the bottom plate 91a of the positive electrode outer packaging body 91) in the lamination direction, a metal portion 72 that is disposed in the through-hole 71, and an insulation layer 73 that is disposed between the through-hole 71 and the metal portion 72.

The through-hole 71 passes through the end surface of the outer packaging body 90 (the bottom plate 91a of the positive electrode outer packaging body 91) in the lamination direction. The size of the through-hole 71 is not particularly limited, and may be appropriately set depending on purpose. For example, the size of the through-hole 71 may be 0.05 mm to 1.0 mm. The shape of the through-hole 71 is not particularly limited, and is typically a circular shape.

The metal portion 72 is a portion that contacts directly with the end portion 24 of the connection portion 22 and is electrically connected to the end portion 24 of the connection portion 22 in the interior of the outer packaging body 90. Since the metal portion 72 is connected to the end portion 24 of the connection portion 22 in the interior of the outer packaging body 90, airtight property and gas barrier property are assured. The metal composing the metal portion 72 is not particularly limited. For example, there are copper, gold, silver, nickel, chrome, and the like. The metal portion 72 may be disposed only in the through-hole 71. However, from a standpoint of increase in connectivity, in addition to the interior of the through-hole 71, the metal portion 72 may be disposed on an inner surface peripheral portion and outer surface peripheral portion of the outer packaging body 90 (the bottom plate 91a of the positive electrode outer packaging body 91) that are continuous with the through-hole 71.

The metal portion 72 and the end portion 24 of the connection portion 22 contact directly with each other and are electrically connected in the interior of the outer packaging body 90, from a standpoint of enhancement in structural efficiency, but the present disclosure is not limited to this form. The metal portion 72 and the end portion 24 of the connection portion 22 may be electrically connected indirectly through a conductive member or the like, in the interior of the outer packaging body 90.

The insulation layer 73 plays a role in insulating the metal portion 72 and the outer packaging body 90 (the positive electrode outer packaging body 91). The insulation layer 73 is disposed between the outer packaging body 90 (the positive electrode outer packaging body 91) and the metal portion 72. In the case where the metal portion 72 is disposed only in the interior of the through-hole 71, the insulation layer 73 may be disposed only on an inside portion of the through-hole 71. In the case where the metal portion 72 is disposed in the interior of the through-hole 71 and on the inner surface peripheral portion and outer surface peripheral portion of the outer packaging body 90 (the bottom plate 91a of the positive electrode outer packaging body 91) that are continuous with the through-hole 71, the insulation layer 73 may be disposed on the inside portion of the through-hole 71 and on an inside peripheral portion and outside peripheral portion of the outer packaging body 90 that are continuous with the through-hole 71. Typically, as described above, the insulation layer 95 is disposed at the portion other than the positive electrode terminal 61 on the bottom plate 91a of the positive electrode outer packaging body 91. Accordingly, typically, the insulation layer 73 constitutes a part of the insulation layer 95, and is disposed on the inside portion of the through-hole 71 and on the inside peripheral portion and outside peripheral portion of the outer packaging body 90 that are continuous with the through-hole 71.

The material of the insulation layer 73 is not particularly limited, and for example, there are polyimide, polypropylene, polyethylene, polyvinylchloride, polytetrafluoroethylene, and the like.

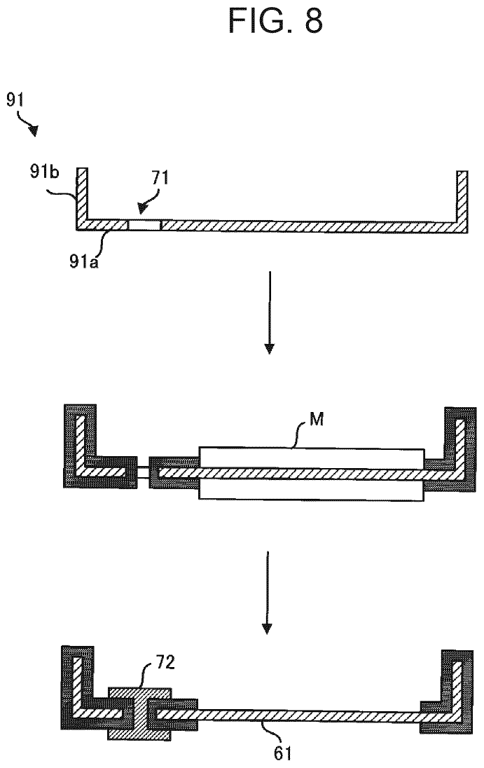

The method for providing the connection terminal 70 on the outer packaging body 90 is not particularly limited, and for example, there is the following method. FIG. 8 shows an example of the method for providing the connection terminal 70 on the outer packaging body 90. FIG. 8 is a sectional view of the positive electrode outer packaging body 91. First, the through-hole 71 is provided at a predetermined position on the bottom plate 91a of the positive electrode outer packaging body 91. Subsequently, a portion of the bottom plate 91a that will become the positive electrode terminal 61 is covered with a predetermined masking member M, and an insulation layer is disposed on the other portion of the bottom plate 91a. Then, the metal portion 72 is disposed in the through-hole 71 provided with the insulation layer 73. Examples of the method for disposing the metal portion 72 include plate processing.

### Effect

In the current collecting plate disposition structure described in JP 2019-53845 A, the through-hole is provided on the outer packaging member, and from the through-hole, the electrode and the voltage monitoring terminal are drawn out to the outside.

On the other hand, in the battery 100, in the interior of the outer packaging body 90, the end-surface positive electrode current collector 11 and the positive electrode terminal 61 are electrically connected, the end-surface negative electrode current collector 12 and the negative electrode terminal 62 are electrically connected, and the connection portions 22 and the connection terminals 70 are electrically connected. Accordingly, in the battery 100, airtight property and gas barrier property are assured, and airtight property and gas barrier property are enhanced compared to the related art. Further, in the battery 100, the end-surface electrode terminal and the connection terminals are disposed on the identical surface. Accordingly, similarly to JP 2019-53845 A, structural efficiency can be enhanced compared to the related art.

The battery in the present disclosure has been described above with use of the embodiment. With the battery in the present disclosure, it is possible to enhance airtight property and gas barrier property and to enhance structural efficiency.

What is claimed is:

1. A battery comprising an electrode laminated body in an interior of an outer packaging body, wherein:
an end-surface positive electrode current collector is disposed on one surface of the electrode laminated body in a lamination direction;
an end-surface negative electrode current collector is disposed on the other surface of the electrode laminated body in the lamination direction;
an internal current collector is laminated in an interior of the electrode laminated body;
the internal current collector includes a connection portion that is drawn out from a side surface of the electrode laminated body;
a positive electrode terminal is disposed on one surface of the outer packaging body in the lamination direction;
a negative electrode terminal is disposed on the other surface of the outer packaging body in the lamination direction;
a connection terminal is disposed on an identical surface to the surface on which at least one of the positive electrode terminal and the negative electrode terminal is disposed; and
in the interior of the outer packaging body, the end-surface positive electrode current collector and the positive electrode terminal are electrically connected, the end-surface negative electrode current collector and the negative electrode terminal are electrically connected, and the connection portion and the connection terminal are electrically connected.

2. The battery according to claim 1, wherein:
the outer packaging body is composed of metal; and
the connection terminal includes
a through-hole that passes through an end surface of the outer packaging body in the lamination direction,
a metal portion that is disposed in the through-hole, and
an insulation layer that is disposed between the through-hole and the metal portion.

3. The battery according to claim 2, wherein the insulation layer is disposed on an inside portion of the through-hole, or on an inside peripheral portion and an outside peripheral portion of the outer packaging body that are continuous with the through-hole.

4. The battery according to claim 1, wherein in the interior of the outer packaging body, the end-surface positive electrode current collector and the positive electrode terminal contact directly with each other, the end-surface negative electrode current collector and the negative electrode terminal contact directly with each other, and the connection portion and the connection terminal contact directly with each other.
